(19) United States
(12) Patent Application Publication
(10) Pub. No.: US 2025/0246636 A1
(43) Pub. Date: Jul. 31, 2025

(54) FLUORIDE ION SECONDARY BATTERY

(71) Applicant: HONDA MOTOR CO., LTD., Tokyo (JP)

(72) Inventor: Kazuyuki SATO, Saitama (JP)

(21) Appl. No.: 18/985,036

(22) Filed: Dec. 18, 2024

(30) Foreign Application Priority Data
Jan. 29, 2024 (JP) 2024-011308

(51) Int. Cl. H01M 4/66; H01M 4/02; H01M 4/38; H01M 4/58; H01M 10/0562

(52) U.S. Cl. CPC H01M 4/663; H01M 4/38; H01M 4/582; H01M 10/0562; H01M 2004/028; H01M 2004/029

(57) ABSTRACT

A fluoride ion secondary battery including an electrode material mixture layer; and a current collecting layer, the current collecting layer having an elastic modulus of 1400 kgf/mm² or less is provided. The current collecting layer may comprise carbon particles. The fluoride ion secondary battery may not comprise a current collecting foil in contact with the current collecting layer.

This application is based on and claims the benefit of priority from Japanese Patent Application No. 2024-011308, filed on 29 Jan. 2024, the content of which is incorporated herein by reference.

### BACKGROUND OF THE INVENTION

### Field of the Invention

The present invention relates to a fluoride ion secondary battery.

### Related Art

In recent years, research and development have been conducted on secondary batteries that contribute to an increase in energy efficiency in order to ensure that more people have access to affordable, reliable, sustainable, and advanced energy.

Patent document 1 describes a fluoride ion battery including at least a positive electrode active material layer and a solid electrolyte layer, the positive electrode active material layer including positive electrode active material particles mainly composed of Cu and Sn, and the solid electrolyte layer including a solid electrolyte containing Pb, Sn, and F.
Patent Document 1: Japanese Unexamined Patent Application, Publication No. 2018-73753

### SUMMARY OF THE INVENTION

However, for the fluoride ion battery described in Patent Document 1, when the positive electrode active material layer expands and contracts with charging and discharging and its volume changes, the volume change is not easily absorbed, resulting in a low initial discharge capacity and a low capacity maintenance rate.

An object of the present invention is to provide a fluoride ion secondary battery that enables improvement of an initial discharge capacity and a capacity maintenance rate.

(1) A fluoride ion secondary battery including:
an electrode material mixture layer; and
a current collecting layer,
the current collecting layer having an elastic modulus of 1400 kgf/mm² or less.

(2) The fluoride ion secondary battery according to (1), in which the current collecting layer includes carbon particles.

(3) The fluoride ion secondary battery according to (2), in which carbon particles are made of acetylene black.

(4) The fluoride ion secondary battery according to any one of (1) to (3), in which the fluoride ion secondary battery does not include a current collecting foil in contact with the current collecting layer.

(5) The fluoride ion secondary battery according to any one of (1) to (4), in which the current collecting layer is in contact with the electrode material mixture layer.

(6) The fluoride ion secondary battery according to (5), in which the electrode material mixture layer is a positive electrode material mixture layer.

(7) The fluoride ion secondary battery according to any one of (1) to (6), in which the fluoride ion secondary battery is a bipolar battery.

The present invention can provide a fluoride ion secondary battery that enables improvement of an initial discharge capacity and a capacity maintenance rate.

### BRIEF DESCRIPTION OF THE DRAWINGS

FIG. 1 is a cross-sectional view showing a fluoride ion secondary battery according to one embodiment of the present invention;

FIG. 2 is a cross-sectional view showing a fluoride ion secondary battery according to another embodiment of the present invention;

FIG. 3 is a cross-sectional view showing a fluoride ion secondary battery according to another embodiment of the present invention; and

FIG. 4 is a graph showing charge-discharge curves (two cycles) of cells of Example 1 and Comparative Example 1.

### DETAILED DESCRIPTION OF THE INVENTION

Hereinafter, embodiments of the present invention will be described with reference to drawings.

### [Fluoride Ion Secondary Battery]

A fluoride ion secondary battery of the present embodiment includes an electrode material mixture layer and a current collecting layer. The current collecting layer has an elastic modulus of 1400 kgf/mm² or less and preferably 1100 kgf/mm² or less. The elastic modulus of the current collecting layer of 1400 kgf/mm² or less improves a capacity maintenance rate of the fluoride ion secondary battery of the present embodiment since, even if a positive electrode material mixture layer expands and contracts with charging and discharging and its volume changes, the volume change is easily absorbed. Note that, the elastic modulus of the current collecting layer is, for example, 1024 kgf/mm² or more.

A material that makes up the current collecting layer is not particularly limited as long as it is an electron-conductive material that can give an elastic modulus of 1400 kgf/mm² or less to the current collecting layer. Among them, carbon particles, for example, are preferred from the viewpoint of an energy density of a fluoride ion secondary battery of the present embodiment. Examples of the carbon particles include, for example, carbon black such as acetylene black or Ketjen black, or graphite particles.

A thickness of the current collecting layer is preferably 40 μm or more and 100 μm or less and further preferably 40 μm or more and 80 μm or less. A thickness of the current collecting layer of 40 μm or more improves a capacity maintenance rate of a fluoride ion secondary battery of the present embodiment and a thickness of 100 μm or less improves an energy density of a fluoride ion secondary battery of the present embodiment.

Note that, the current collecting layer is preferably in contact with a positive electrode material mixture layer. This can prevent overcharging since, for example, the material that makes up the current collecting layer is fluorinated to become an insulator in the case of a high voltage.

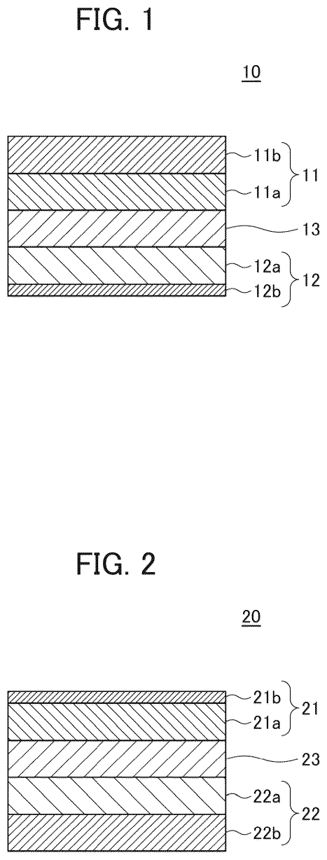

FIG. 1 shows a fluoride ion secondary battery according to one embodiment of the present invention.

A fluoride ion secondary battery 10 includes a positive electrode 11, a negative electrode 12, and a solid electrolyte layer 13 disposed between the positive electrode 11 and the negative electrode 12. Here, the positive electrode 11 includes a positive electrode material mixture layer 11a and a positive electrode current collecting layer 11b. The negative electrode 12 includes a negative electrode material mixture layer 12a and a negative electrode current collecting foil 12b. Note that, the positive electrode 11 may further include a positive electrode current collecting foil in contact with the positive electrode current collecting layer 11b, but preferably does not include a positive electrode current collecting foil from the viewpoint of cost.

FIG. 2 shows a fluoride ion secondary battery according to another embodiment of the present invention.

A fluoride ion secondary battery 20 includes a positive electrode 21, a negative electrode 22, and a solid electrolyte layer 23 disposed between the positive electrode 21 and the negative electrode 22. Here, the positive electrode 21 includes a positive electrode material mixture layer 21a and a positive electrode current collecting foil 21b. The negative electrode 22 includes a negative electrode material mixture layer 22a and a negative electrode current collecting layer 22b. Note that, the negative electrode 22 may further include a negative electrode current collecting foil in contact with the negative electrode current collecting layer 22b, but preferably does not include a negative electrode current collecting foil from the viewpoint of cost.

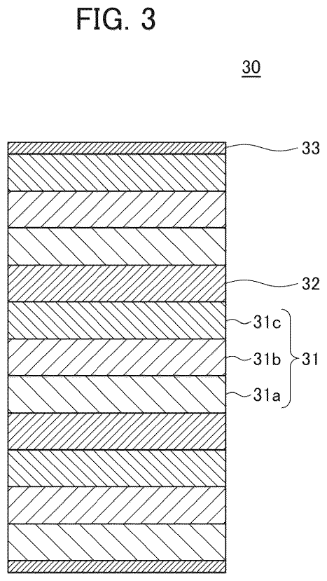

FIG. 3 shows a fluoride ion secondary battery according to another embodiment of the present invention.

A fluoride ion secondary battery 30 is a bipolar battery including a plurality of cells 31, a current collecting layer 32 disposed between the plurality of cells 31, and a current collecting foil 33. This can reduce an amount of outer packaging and thus improve an energy density of the fluoride ion secondary battery 30. Here, the cell 31 includes a negative electrode material mixture layer 31a, a solid electrolyte layer 31b, and a positive electrode material mixture layer 31c successively laminated, and the current collecting layer 32 is disposed between a positive electrode material mixture layer 31c and a negative electrode material mixture layer 31a constituting an adjacent cell 31. Current collecting foils 33 are disposed on a side of an uppermost cell 31 on which the current collecting layer 32 is not disposed, and beneath a lowermost cell 31. In this case, the current collecting foil 33 in contact with the negative electrode material mixture layer 31a serves as a negative electrode current collecting foil, and the current collecting foil 33 in contact with the positive electrode material mixture layer 31c serves as a positive electrode current collecting foil.

### (Positive Electrode Material Mixture Layer)

A positive electrode material mixture layer includes a positive electrode active material and may further include a solid electrolyte, a conductive aid, or the like, as needed.

The positive electrode active material is not particularly limited and, for example, may be Cu particles or Bi particles. Here, when Cu particles are used as the positive electrode active material, a volume change of the positive electrode material mixture layer with charging and discharging is larger. Therefore, the above-mentioned current collecting layer is particularly effective.

Examples of a positive electrode active material other than Cu particles or Bi particles include particles of a compound represented by General formula:

KₓBi₁₋ₓF₃₋₂ₓ

where x is 0.02 or more and 0.12 or less.

The positive electrode active material is preferably in a form of nanoparticles. A diameter of the positive electrode active material is, for example, 10 nm or more and 100 nm or less.

A solid electrolyte is not particularly limited as long as it is fluoride ion-conductive and is not defluorinated during discharge of a fluoride ion secondary battery. Examples thereof include metal fluoride particles. Examples of the metal fluoride particles include, for example, Ce_{0.92}Sr_{0.08}F_{2.92} particles.

The solid electrolyte is preferably in a form of nanoparticles. A diameter of the solid electrolyte is, for example, 10 nm or more and 100 nm or less.

A conductivity aid is not particularly limited as long as it has electron conductivity. Examples thereof include acetylene black.

### (Negative Electrode Material Mixture Layer)

A negative electrode material mixture layer includes a negative electrode active material and may further include a conductive aid, or the like, as needed. The negative electrode active material is not particularly limited and, for example, may be PbSnF₄ particles. A conductivity aid is not particularly limited as long as it has electron conductivity. Examples thereof include acetylene black.

### (Solid Electrolyte Layer)

A solid electrolyte that makes up a solid electrolyte layer is not particularly limited as long as it is fluoride ion-conductive and is not defluorinated during discharge of a fluoride ion secondary battery. Examples thereof include a metal fluoride. Examples of the metal fluoride include, for example, Ce_{0.95}Sr_{0.05}F_{2.85}.

### (Positive Electrode Current Collecting Foil)

A positive electrode current collecting foil is not particularly limited as long as it has electron conductivity. Examples thereof include a metal foil such as a gold foil or a platinum foil.

### (Negative Electrode Current Collecting Foil)

A negative electrode current collecting foil is not particularly limited as long as it has electron conductivity. Examples thereof include a metal foil such as an aluminum foil.

A fluoride ion secondary battery of the present embodiment is obtained, for example, by sequentially laminating a positive electrode current collecting layer, a powder composition for a positive electrode material mixture layer, a solid electrolyte layer, a powder composition for a negative electrode material mixture layer, and a negative electrode collector foil, followed by press molding. Here, the powder composition for a positive electrode material mixture layer includes, for example, a positive electrode active material, a solid electrolyte, and a conductive aid. The powder composition for a negative electrode material mixture layer includes, for example, a negative electrode active material and a conductive aid.

Embodiments of the present invention have been described above, but the present invention is not limited to the above embodiments and the embodiment may be modified as appropriate within the scope of the invention.

### EXAMPLES

Although Examples of the present invention will be described hereinafter, the present invention is not limited to the Examples.

(K_{0.06}Bi_{0.94}F_{2.88} Powder)

First, potassium fluoride (manufactured by Kojundo Chemical Laboratory Co., Ltd.) and bismuth fluoride (manufactured by Kojundo Chemical Laboratory Co., Ltd.) were weighed and then premixed with an agate mortar and a pestle for about 1 hour to thereby obtain a raw material mixed powder.

The resulting raw material mixed powder was classified using a stainless steel mesh with a 500 μm aperture. Next, a procedure of mixing the raw material mixed powder that remained on the mesh using an agate mortar and pestle and classifying it was repeated until all the raw material mixed powder passed through the mesh.

Note that, the raw materials were weighed, premixed, and classified in a purge-type (DBO type) glove box (manufactured by Miwa Manufacturing Co., Ltd.) in order to prevent a fluoride from absorbing moisture.

A closed powder hopper which was filled with the thus-classified raw material mixed powder was removed from the glove box and then connected to a high-frequency induction thermal plasma nanoparticle synthesizer TP-40020NPS (manufactured by JEOL Ltd.). Next, an argon gas was supplied to a plasma torch and the raw material mixed powder was melted by thermal plasma to form a raw material melt, which was then sprayed into a chamber under a reduced pressure. The raw material melt which had been sprayed into the chamber was cooled and formed into nanoparticles, resulting in K_{0.06}Bi_{0.94}F_{2.88} powder. Then, the K_{0.06}Bi_{0.94}F_{2.88} powder was collected by an exhaust gas filter. After blocking upstream and downstream of the exhaust gas filter by valves, the exhaust gas filter was taken into the glove box and K_{0.06}Bi_{0.94}F_{2.88} powder having a particle diameter of 10 nm or more and 100 nm or less was collected. A composition of the K_{0.06}Bi_{0.94}F_{2.88} powder was analyzed by inductively coupled plasma emission spectroscopy.

### (Cu Powder)

Cu powder having a particle diameter of 10 nm or more and 100 nm or less was obtained in the same manner as for the K_{0.06}Bi_{0.94}F_{2.88} powder, except that copper (manufactured by Kojundo Chemical Laboratory Co., Ltd.) was used instead of the raw material mixed powder.

(Ce_{0.92}Sr_{0.08}F_{2.92} Powder)

First, cerium fluoride (manufactured by Kojundo Chemical Laboratory Co., Ltd.) and strontium fluoride (manufactured by Kojundo Chemical Laboratory Co., Ltd.) were weighed and then premixed with an agate mortar and a pestle for about 1 hour to thereby obtain a raw material mixed powder.

Ce_{0.92}Sr_{0.08}F_{2.92} powder having a particle diameter of 10 nm or more and 100 nm or less was obtained in the same manner as for the K_{0.06}Bi_{0.94}F_{2.88} powder, except that the resulting raw material mixed powder was used. A composition of the Ce_{0.92}Sr_{0.08}F_{2.92} powder was analyzed by inductively coupled plasma emission spectroscopy.

### (Powder Composition for Positive Electrode Material Mixture Layer)

A powder composition for a positive electrode material mixture layer was prepared in a purge-type (DBO type) glove box (manufactured by Miwa Manufacturing Co., Ltd.) filled with an argon gas. Specifically, 0.524 g of Cu powder, 0.175 g of Bi powder (manufactured by Kojundo Chemical Laboratory Co., Ltd.), and 0.154 g of K_{0.06}Bi_{0.94}F_{2.88} powder serving as a positive electrode active material; 0.129 g of Ce_{0.92}Sr_{0.08}F_{2.92} powder serving as a solid electrolyte; and 0.018 g of acetylene black (manufactured by Denka Company Limited) as a conductive aid were weighed. Next, the thus-weighed materials were ball-milled in 8 g of cyclohexane using a silicon nitride pot mill having a volume of 45 mL and 40 g of silicon nitride balls each having a diameter of 2 mm, followed by drying on a hot plate at 65° C. to obtain a powder composition for a positive electrode material mixture layer. During the ball-milling of the weighed materials, 40 cycles of ball milling at 200 rpm for 15 minutes followed by a 5-minute pause were performed.

### (Powder Composition for Negative Electrode Material Mixture Layer)

Six grams of lead fluoride (manufactured by Kojundo Chemical Laboratory Co., Ltd.) and 2.8 g of stannous fluoride (manufactured by Kojundo Chemical Laboratory Co., Ltd.) were ball-milled using a silicon nitride pot mill having a volume of 45 mL and ten silicon nitride balls having a diameter of 10 mm. During the ball-milling, 8 cycles of ball milling at 600 rpm for 3 hours followed by a 5-minute pause were performed. Next, 0.619 g of acetylene black was added to 8.669 g of the resulting mixture, which was ball-milled in the same manner as above and then heat-treated at 400° C. for 1 hour under an argon atmosphere to obtain a powder composition for a negative electrode material mixture layer.

(Ce_{0.95}Sr_{0.05}F_{2.85} Powder)

19.3510 g of cerium fluoride (manufactured by Kojundo Chemical Laboratory Co., Ltd.) and 0.6490 g of strontium fluoride (manufactured by Kojundo Chemical Laboratory Co., Ltd.) were ball-milled, then calcined at 1100° C. for 6 hours under argon atmosphere to obtain Ce_{0.95}Sr_{0.05}F_{2.85} powder. During the ball-milling, 40 cycles of ball milling at 600 rpm for 1 hour followed by a 5-minute pause were performed.

### Example 1

A cell was prepared using an alumina tube having an inner diameter of 10 mm in a purge-type (DBO type) glove box (manufactured by Miwa Manufacturing Co., Ltd.) filled with an argon gas. Specifically, first, 150 mg of Ce_{0.95}Sr_{0.05}F_{2.85} powder serving as a solid electrolyte was uniaxially pressed at 740 MPa of a surface pressure to obtain a solid electrolyte layer. Next, an Au foil having a thickness of 20 μm serving as a positive electrode current collecting foil, 10 mg of a powder composition for a positive electrode material mixture layer, a solid electrolyte layer, 20 mg of a powder composition for a negative electrode material mixture layer, and 15.6 mg of acetylene black were sequentially laminated, then uniaxially pressed at 185 MPa to obtain a cell including a negative electrode current collecting layer. The negative electrode current collecting layer had a thickness of 100 μm and an elastic modulus of 1024 kgf/mm². The cell was then filled into a sealed glass container with a confining pressure of about 340 MPa.

### [Method for Measuring Elastic Modulus]

An elastic modulus was determined by sandwiching a current collecting layer between two plates and obtaining a compression-strain property.

### Example 2

A cell including a positive electrode current collecting layer was obtained in the same manner as in Example 1, except that 15.6 mg of acetylene black was used instead of the Au foil having a thickness of 20 μm, and an Al foil having a thickness of 20 μm serving as a negative electrode collector foil was used instead of 15.6 mg of acetylene black. The positive electrode current collecting layer had a thickness of 100 μm and an elastic modulus of 1038 kgf/mm².

### Example 3

A cell including a positive electrode current collecting layer was obtained in the same manner as in Example 1, except that 15.6 mg of acetylene black was used instead of the Au foil having a thickness of 20 μm. The positive electrode current collecting layer and the negative electrode current collecting layer each had a thickness of 100 μm and an elastic modulus of 1052 kgf/mm².

### Comparative Example 1

A cell was obtained in the same manner as in Example 1, except that an Al foil having a thickness of 20 μm serving as a negative electrode collector foil was used instead of 15.6 mg of acetylene black.

### [Discharge Capacity]

Using the Potentiostat Galvanostat SI1287/1255B (manufactured by Solartron Analytical), a constant-current charge-discharge test was performed on a cell at a temperature of 140° C., which temperature was obtained by reducing a pressure inside of a glass container by a vacuum pump and placing the glass container in a thermostatic bath. Specifically, the cell was charged by applying a current of 120 μA and then a current of 40 μA until a voltage reached 1.5 V (vs. Pb/PbF₂). Next, the cell was discharged by applying a current of 120 μA and then a current of 40 μA until a voltage reached −0.5 V (vs. Pb/PbF₂). In this test, the above cycle was repeated twice to obtain a discharge capacity.

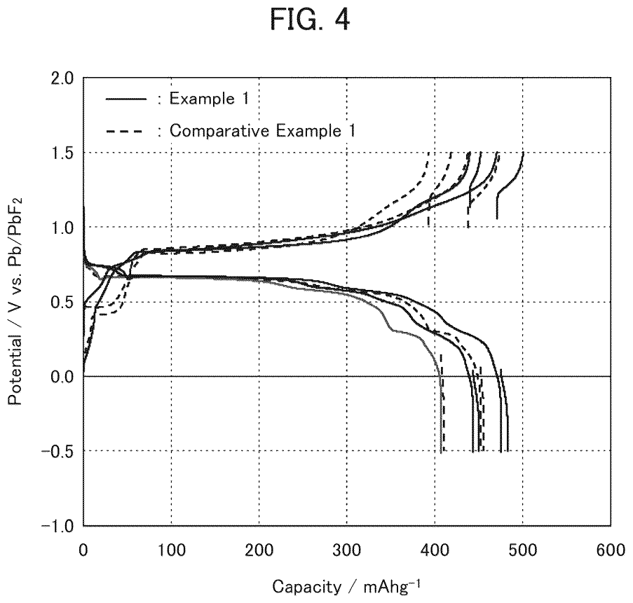

FIG. 4 shows charge-discharge curves of cells of Example 1 and Comparative Example 1. Note that, a capacity on the horizontal axis is a capacity per gram of a positive electrode material mixture layer.

It can be seen from FIG. 4 that the cell of Example 1 had a higher initial discharge capacity than the cell of Comparative Example 1.

### [Capacity Maintenance Rate]

A ratio of a discharge capacity at a second cycle to an initial discharge capacity was determined and used as a capacity maintenance rate.

Table 1 shows evaluation results of cells for an initial charge capacity, an initial discharge capacity, and a capacity maintenance rate.

TABLE 1

| | | Initial discharge | Capacity |
|---|---|---|---|
| | Current collecting | capacity | maintenance |
| | layer | [mAhg⁻¹] | rate [%] |
| Example 1 | Negative electrode | 482 | 92 |
| Example 2 | Positive electrode | 485 | 92 |
| Example 3 | Positive electrode/ | 481 | 91 |
| | Negative electrode | | |
| Comparative | — | 455 | 90 |
| Example 1 | | | |

It can be seen from Table 1 that the cells of Examples 1 to 3 have high initial discharge capacities and capacity retention rates. In contrast, the cell of Comparative Example 1 has a low initial discharge capacity and capacity retention rate since it does not include a current collecting layer having an elastic modulus of 1400 kgf/mm² or less.

### EXPLANATION OF REFERENCE NUMERALS

10, 20 Fluoride ion secondary battery
11, 21 Positive electrode
11a, 21a, 31c Positive electrode material mixture layer
11b Positive electrode current collecting layer
21b Positive electrode current collecting foil
12, 22 Negative electrode
12a, 22a, 31a Negative electrode material mixture layer
12b Negative electrode current collecting foil
22b Negative electrode current collecting layer
13, 23, 31b Solid electrolyte layer
31 Cell
32 Current collecting layer
33 Current collecting foil

What is claimed is:

1. A fluoride ion secondary battery comprising:
an electrode material mixture layer; and
a current collecting layer,
the current collecting layer having an elastic modulus of 1400 kgf/mm² or less.

2. The fluoride ion secondary battery according to claim 1, wherein the current collecting layer comprises carbon particles.

3. The fluoride ion secondary battery according to claim 2, wherein carbon particles are made of acetylene black.

4. The fluoride ion secondary battery according to claim 1, wherein the fluoride ion secondary battery does not comprise a current collecting foil in contact with the current collecting layer.

5. The fluoride ion secondary battery according to claim 1, wherein the current collecting layer is in contact with the electrode material mixture layer.

6. The fluoride ion secondary battery according to claim 5, wherein the electrode material mixture layer is a positive electrode material mixture layer.

7. The fluoride ion secondary battery according to claim 1, wherein the fluoride ion secondary battery is a bipolar battery.
